(19) United States
(12) Patent Application Publication
(10) Pub. No.: US 2014/0268766 A1
(43) Pub. Date: Sep. 18, 2014

(54) DIRECT-INDIRECT LUMINAIRE HAVING CONFIGURABLE PLANAR LIGHT PANELS

(71) Applicant: ABL IP Holding, LLC, Conyers, CA (US)

(72) Inventor: Min-Hao Michael Lu, Castro Valley, CA (US)

(21) Appl. No.: 14/217,138

(22) Filed: Mar. 17, 2014

Related U.S. Application Data
(60) Provisional application No. 61/799,690, filed on Mar. 15, 2013.

(51) Int. Cl. F21V 21/30

(52) U.S. Cl. CPC F21V 21/30
USPC 362/249.1

(57) ABSTRACT

A direct-indirect luminaire 11 is comprised of a support frame 23, 25 for supporting multiple planar light sources 15 that emit light from both their top and bottom planar surfaces 17, 19 for producing up-light and down-light in characteristic light distribution patterns. The planar light sources, which are preferably edge-fed light waveguides, can be supported in the support frame in different rotational orientations that can be changed to change the light distribution characteristics of the luminaire.

### CROSS-REFERENCE TO RELATED APPLICATIONS

This application claims the benefit of U.S. Provisional Application No. 61/799,690 filed Mar. 15, 2013, which is incorporated herein by reference.

### BACKGROUND

The present invention generally relates to luminaires for illuminating a space, and more particularly to luminaires that produce both direct lighting and indirect lighting from the same luminaire.

Conventional direct-indirect luminaires provide a distribution of light both above and below the fixtures, sometimes referred to as up-light and down-light. Generally, these distributions are based on the design of the luminaire and the optical systems used. Each luminaire will have an up and down light distribution that is characteristic of that luminaire. Light designers will typically select a luminaire based the fixture's light distribution characteristics as well as aesthetic considerations, that is, how well the physical luminous characteristics work in an architectural space.

The present invention provides a direct-indirect luminaire having a unique aesthetic appeal and the flexibility to create different up and down light distribution patterns. The luminaire can easily be reconfigured to change the up light distribution produced from the luminaire relative to its down light distribution.

### SUMMARY OF THE INVENTION

The invention is directed to a luminaire that produces both direct and indirect lighting. The luminaire is comprised of a support frame for supporting multiple substantially identical planar light sources that emit light from both their top and bottom planar surfaces for producing up-tight and down-light in characteristic tight distribution patterns. The planar light sources, which are preferably edge-fed light waveguides, can be supported in the support frame in different rotational orientations that can be changed to change the light distribution characteristics of the luminaire. Thus, a luminaire capable of producing different light distributions can be provided with a minimum of component parts.

In one aspect of the invention, each of the multiple planar light sources of the luminaire has a rotationally asymmetric distribution pattern, such as a bilateral bat-wing up-light distribution pattern, and a down-light distribution pattern that is substantially rotationally symmetric, such as a cosine distribution pattern or a compressed cosine distribution pattern. By changing the rotational orientation of the planar light sources in the mounting frame, the up-light distribution pattern can be changed, such as from a composite bilateral bat-wing distribution pattern in either the x or the y axis, or a quadralaterally symmetric composite bat-wing distribution pattern.

In another aspect of the invention, a new mounting frame is provided for supporting multiple planar light sources that produce both up-light and down-light. The support frame is comprised of an inner support ring and outer support ring, and include means, such as rim support trays secured between the inner and outer support rings, for supporting the planar light sources between these support rings in desired orientations. The light panels are removable from their support means, and their support means allow the light panels to be placed therein in selected orientations.

### BRIEF DESCRIPTION OF THE DRAWINGS

FIG. 1 is a bottom perspective view of a luminaire in accordance with e invention.

FIG. 2 is a top plan view thereof.

FIG. 3 is a side elevational view thereof.

FIG. 4A is an enlarged plan view of one of the light panels used in the luminaire shown in FIGS. 1-3.

FIG. 4B is another enlarged plan view thereof showing an alternate wiring scheme.

FIG. 5 is an enlarged fragmentary view thereof in cross-section showing a light panel exploded from the support frame of the luminaire.

FIG. 6A is an enlarged fragmentary view thereof in cross-section showing suspension points for the luminaire.

FIG. 6B is the same fragmentary view further enlarged.

FIG. 7A is another enlarged fragmentary view thereof showing a different cross-sectional view and different aspects of the luminaire.

FIG. 7B is the same fragmentary view further enlarged.

FIG. 8 is a further enlarged fragmentary view thereof showing a different cross-sectional view and different aspects of the luminaire.

FIG. 9A-9C is a graphical representation of different possible orientations of the light panel of the luminaire illustrated in the foregoing figures to achieve different light distributions.

FIGS. 10A and 10B show representative up- and down-light distribution patterns that can be produced from the four panel luminaire illustrated in the foregoing figures.

### DETAILED DESCRIPTION OF THE ILLUSTRATED EMBODIMENT

Referring now to the drawings, a luminaire 11 in accordance with the invention is shown suspended by suspension cables 12a, 12b from an overhead ceiling structure, denoted by dashed lines 13, for illuminating a space by both direct and indirect lighting. The direct and indirect light from the luminaire is emitted from a series of planar light sources in the form of light panels 15a, 15b, 15c, 15d (collectively light panels 15), each having a top planar tight emitting surface 17a, 17b, 17c, 17d (collectively top planar surfaces 17), and a bottom planar emitting surface 19a, 19b, 19c, 19d (collectively bottom planar surfaces 19). Indirect light, or up-light, is emitted from the top planar surfaces of the light panels to produce an up-light distribution pattern, and direct light, or down-light, is emitted from the bottom planar surfaces of the light panels to produce a down-light distribution pattern. As later described, the distribution pattern of the up-light is different from the distribution patter of the down-light, providing the capability of reconfiguring the light panels to create a different distribution of light from the luminaire.

The light panels 15 are held in a support frame 21, which permits the top and bottom planar surfaces 17, 19 of panels 15 to emit up- and down-light from the luminaire which is substantially unobstructed by the frame. The support frame can be comprised of inner support ring 23, outer support ring 25, and panel support means such as hereinafter described for removably holding the light panels between the rings. The light panels are configured so that they can be placed in the support frame in different orientations. Thus, where one or more, and preferably all of the light panels have an asymmetric light distribution pattern, the light panels can be advantageously rotated within the support frame to alter the light distribution pattern of the luminaire. As hereinafter described, in one aspect of the invention, it is contemplated that the distribution pattern of the light emitted from the top planar surfaces of the light panels will be an asymmetric distribution pattern and that the distribution pattern of the light emitted from the bottom of the panels will be a symmetric distribution pattern. Rotation of the light panels within the support frame thus change the up-light distribution pattern, but not the down-tight distribution pattern.

Light panels 15 are most suitably square panels, and each panel can include a light waveguide 29 secured within a square perimeter frame 31. The perimeter frame holds rows of LEDs 33 along opposed edges 35 of waveguide 29 such that the LEDs are positioned to feed light into the waveguide edges. In a manner well known in the art, light fed into the waveguide at the waveguide edges travels down the waveguide by internal reflections and is extracted through the surface or surfaces of the waveguides by suitable light extraction means. (Light waveguides and means for extracting light from light waveguides are described in U.S. Patent Application Publication No. 2010-0220497, which is incorporated herein by reference.) The top surface of the light waveguide provides the top planar light emitting surface 17 of light panels 15, and the bottom surface of the light waveguide provides the panel's bottom planer light emitting surface, and each surface can be provided with light extraction means for producing a desired light distribution from the surfaces. Light extraction through the top surface of the waveguide can, for example, be provided by micro-prisms on the waveguide's top surface, which are formed to produce an asymmetric up-light distribution pattern. On the other hand, a diffuse layer or layers applied to the bottom surface can extract light through this surface in a symmetric cosine down-light distribution. An additional microprismatic layer can be added to the bottom surface to provide some focusing of the symmetric down-tight distribution pattern in order to reduce glare at high viewing angles.

For the LED light sources 33, strips of LEDs contained within the perimeter frame can be connected in series with a positive lead wire 37 exiting from one corner region 39 of the perimeter frame and a negative lead wire 41 exiting an adjacent corner region 43. By having the lead wires exit the light panels at the corners of the panels, wire connections in the support frame can be made with a minimal amount of wire and wire travel.

It can be seen that the illustrated inner and outer support rings 23, 25 of the support frame support the light panels in one of two 90 degree orientations. The illustrated inner support ring 23 is an elongated ring having a long dimension and short dimension, and is comprised of a substantially vertically extending support wall 45 that provides a substantially vertical inner wall surface 47 and a substantially vertical outer wall surface 49. The inner support ring includes two outer corner regions 51, 53 in the long dimension, two inner corner regions 55, 57 in the short dimension, and straight wall sections 59a, 59h, 59c, 59d extending between the corner regions. As hereinafter described, the corner regions of the inner ring will provide suspension points for suspending the luminaire from an overhead ceiling. They will also provide points where the luminaire can be wired to an external power source.

The illustrated outer ring 25, which is a larger ring sized and shaped to provide a surround about the inner ring, is comprised of substantially vertically extending support wall 61 having a substantially vertical inner wall surface 62, and includes straight wail sections 63a, 63b, 63c, 63d positioned in opposition to the straight wall sections 59a, 59b, 59c, 59d of the inner ring. It is seen that the inner and outer rings can be in different planes. In the illustrated embodiment, the outer ring is slightly elevated relative to the inner ring. This will provide flexibility in the design of the luminaire both in terms of visual interest and lighting performance.

Light panel support means associated with the inner and outer support rings allow the light panels 15 to be held in place and supported by the rings. In the illustrated embodiment, the light panel support means is comprised of rim support trays 65 secured to and extending between the straight wail sections 59a, 59b, 59c, 59d of the inner ring 23 and the opposed straight wall sections 63a, 63b, 63c, 63d of the outer support ring 25. Each rim support tray is formed by L-shaped rails 67 configured in a square and suitably sized for receiving and holding one of the light panels 15. The in-turned leg 69 of the L-shaped rail frames an opening 71 sized to expose the bottom planar surface 17 of the light panel held in the tray. Attachment of the rim trays between the inner and outer support rings 23, 25 of the support frame can be accomplished by suitable fasteners 72, 73 that fasten vertical walls 74, 76 of the rails to opposed vertical walls 45, 61 of the support rings.

In addition to supporting light panels 15, the rim support trays will also provide a structural connection between the inner and outer support rings 23, 25. As best seen in FIG. 5, opposed inner and outer L-shaped rails of the rim support tray can have a bend angle that angulates the rim trays relative to the vertical walls 45, 61 of the support rails, thereby causing one of the support rails to be elevated relative to the other support rail. In the illustrated embodiment, inner and outer support rails have L-angles that cause the outer ring to be slightly elevated relative to the inner rail.

As mentioned above, the corner regions 51, 53, 55, 57 of the inner support ring of the support frame provide both suspension points and points where the luminaire can be wired to an external power source. Preferably they will be powered by a low voltage source, for example 36 volts, such that electrical power is delivered to the luminaire through the suspension cables 12a and 12b. FIGS. 6A, 6B and 7A, 7B show one of the outer suspension cables 12a connected to an outer terminal block 93 fastened by fastener 94 to the inside surface 49 of the inner ring's vertical wall 45 at one of the outer corner regions (corner region 51) of the inner ring. One of these outer terminal blocks can similarly be fastened to the inner ring at the ring's other outer corner region corner region 53). When the light panels are placed in the rim support trays 65, the corner of the panels having the negative lead wire (shown in FIGS. 4A and 4B) can be oriented such that the negative lead corner of the panels lies immediately adjacent the inner ring's outer corner regions. With this orientation, the negative leads can be attached to the outer terminal blocks with vet short wire spans. A finished appearance can in turn be maintained at the outer corner regions of the inner ring by terminal block covers 75, 79 which have wire-way extensions 77, 81 for the panel's negative lead wires.

FIGS. 6A, 6B and 7A, 7B, in addition to FIG. 8, further show one of the inner suspension cables 12b connected to an inner terminal block 91 fastened by fastener 92 (shown in FIG. 8) to the inside surface 49 of the inner ring's vertical wall 45 at one of the inner corner regions (corner region 57) of the inner ring. One of these inner terminal blocks can similarly be fastened to the inner ring at the ring's other inner corner region (corner region 55). The orientation of the light panels in rim support trays can be such that the positive lead corner of the panels lies immediately adjacent the inner ring's inner corner regions. With this orientation, the positive leads can be attached to the inner terminal blocks with very short wire spans. A finished appearance can again be maintained at the inner corner regions of the inner ring by terminal block covers 87 which have wire-way extensions 89 for the panel's positive lead wires.

FIGS. 9A-9C and 10A-10B illustrate how the light panels 15 of the luminaire can be configured and reconfigured to produce different up-light distribution patterns white retaining the same direct light distribution pattern. The light panels can be designed such that the up-light emitted from the top of the panels produces a bilateral bat-wing up-light distribution as indicated by the up-light distribution curves U in FIGS. 10A and 10B, showing exemplary up-light and down-light distribution curves for any one of the panels in the X-Z plane and the Y-Z plane. As further shown in FIGS. 10A and 10B, the same panel can produce a symmetric cosine distribution or a near cosine or compressed distribution (one having a cut-off at high viewing angles) from the bottom of the panels as denoted by distribution curve D. These distribution characteristics can be obtained from light panels comprised of edge-fed light waveguides as described above,

FIGS. 9A-9B graphically illustrate different possible orientations of the light panels 15 in the luminaire's support frame 21 for achieving different overall overhead (up-light) distributions from the luminaire using the same basic light panel component, wherein each produces a distribution pattern such as illustrated in FIGS. 10A and 10B. In FIG. 9A identical light panels 15a, 15b, 15c, 15d. having LED fed edges 35 are shown in a rotation that produces a composite bilateral bat-wing up-light distribution pattern along the x-axis. FIG. 9B shows a panel orientation for producing a composite bi-lateral bat-wing up-light distribution along the y-axis. This change in orientation can be readily achieved in the luminaire above-described by disconnecting the lead wires 37, 39 of the panels at the respective outer and inner corner regions of the inner ring, removing and rotating the light panels from their respective rim support trays 65 between the inner and outer rings of the luminaire, rotating them, and then re-installing them.

In FIG. 9C light panels 15a, 15b, 15c, 15d. are oriented such that the bilateral bat-wing up-light distribution patterns s of the individual panels do not line up. Rather, the bilateral bat-wing up-light distribution pattern of light panels 15a. and 15d are at right angles to the bilateral bat-wing up-light distribution pattern of light panels 15b and 15c, resulting in an approximately quadralaterally symmetric composite bat-wing distribution pattern. With change in the orientation of the light panels in the luminaire's illustrated support frame, the lead wires 37, 39 would preferably be rerouted so that they exit the desired corners of the light panels as discussed above.

It is noted that the different orientations of the light panels shown in FIGS. 9A-9C do not significantly affect the down-light distribution of the luminaire, which is the composite of the rotationally symmetric approximate cosine distributions produced by each panel.

While one embodiment of the invention has been described in considerable detail in the foregoing specification, it shall be understood that it is not intended that the invention be limited to such detail, and that variations of the described embodiment are possible which are within the scope of the invention. For example, light panels other than square light panels, such as rotationally symmetric polygonal panels, could be used. Also, consideration can be given to the use of planar light sources other than edge-fed tight waveguides.

What I claim is:

1. A luminaire comprising
at least two planar light sources having a top light emitting planar surface for producing a characteristic up-light distribution pattern and a bottom light emitting planar surface for producing a characteristic down-light distribution pattern, and
a support frame for supporting planar light sources such that each of said light sources can emit up-light and down-light substantially unobstructed by said support frame, said support frame being adapted to allow the planar light sources to be removed and reinstalled in the support frame in a different rotated orientation relative to each other.

2. The luminaire of claim 1 wherein said mounting frame includes an inner support ring, an outer support ring, and means for connecting each of said planar light sources between said support rings at a selected rotated orientation, wherein the planar light sources can be supported between said support rings at different rotated orientations relative to each other.

3. The luminaire of claim 2 wherein at least one of said inner and outer support rings includes suspension points for the luminaire and points where the luminaire can be wired to an external power source.

4. The luminaire of claim 2 wherein said inner ring includes the suspension points for the luminaire and points where the luminaire can be wired to an external power source.

5. The luminaire of claim 1 wherein the top light emitting planar surface of each of said planar light sources produces a rotationally asymmetric distribution pattern, and the bottom light emitting planar surface of each of said planar light sources produce a substantially rotationally symmetric distribution pattern.

6. The luminaire of claim 1 wherein the top light emitting planar surface of each of said planar light sources produces a bat wing distribution pattern, and the bottom light emitting planar surface of each of said planar light sources produces a the substantially rotationally symmetric distribution pattern.

7. The luminaire of claim 6 wherein the bottom light emitting planar surface of each of said planar light sources produces a substantially cosine distribution pattern.

8. The luminaire of claim 1 wherein four planar light sources provided each of which has a top light emitting planar surface for producing a characteristic up-light distribution pattern and a bottom light emitting planar surface for producing a characteristic down-light distribution pattern, and wherein said planar light sources are supported in said support frame such that each of said light sources can emit up-light and down-light substantially unobstructed by said support frame, said support frame being adapted to allow the four planar light sources to be removed and reinstalled in the support frame in a different rotated orientation relative to each other.

9. A luminaire comprising
an outer support ring, and
a plurality of planar light sources having a top light emitting planar surface for producing a characteristic up-light distribution pattern and a bottom light emitting planar surface for producing a characteristic down-light distribution pattern, each of said planar light sources between being supported between said inner and outer support rings at different possible rotated orientations, wherein, when supported between said inner and outer support rings, the support rings and planar light sources form a luminaire with an up-light and down-light distribution pattern the depends on the rotated orientations of the planar light sources supported between said inner and outer support rings.

10. The luminaire of claim 9 wherein said inner and outer support rings have corner regions and straight wall sections extending between said corner regions, wherein straight wall sections of said inner support ring oppose straight wall sections of said outer ring, and wherein the planar light sources are supported between opposed straight wall sections of said inner and outer support rings.

11. The luminaire of claim 10 wherein the corner regions of at least one of said inner and outer support rings includes suspension points for the luminaire and points where the luminaire can be wired to an external power source.

12. The luminaire of claim 10 wherein the corner regions of said inner ring includes suspension points for the luminaire and points where the luminaire can be wired to an external power source.

13. The luminaire of claim 10 wherein the planar light sources have different opposite substantially straight perimeter edges that will align with opposed straight wall sections of said inner and outer support rings between which the planar light sources are supported.

14. The luminaire of claim 13 wherein the planar light sources are substantially square planar light sources.

15. The luminaire of claim 9 wherein the top light emitting planar surface of each of said planar light sources produces a rotationally asymmetric distribution pattern, and the bottom light emitting planar surface of each of said planar light sources produce a substantially rotationally symmetric distribution pattern.

16. The luminaire of claim 9 wherein the top light emitting planar surface of each of said planar light sources produces a bat wing distribution pattern, and the bottom light emitting planar surface of each of said planar light sources produces a the substantially rotationally symmetric distribution pattern.

17. The luminaire of claim 16 wherein the bottom light emitting planar surface of each of said planar light sources produces a substantially cosine distribution pattern.

18. A luminaire comprising
an inner support ring having corner regions and straight wall sections,
an outer support ring having corner regions and straight sections corresponding with the corner regions and straight sections of said inner support ring, and wherein straight wall sections of said inner support ring oppose straight wall sections of said outer ring,
the corner regions of at least one of said inner and outer support rings including suspension points for the luminaire and points where the luminaire can be wired to an external power source
a plurality of planar light sources having a top light emitting planar surface for producing a rotationally asymmetric up-light distribution pattern and a bottom light emitting planar surface for producing a substantially rotationally symmetric down-light distribution pattern,
each of said planar light sources between being supported between the straight wall sections of said inner and outer support rings at different possible rotated orientations, wherein, when supported between said inner and outer support rings, the support rings and planar light sources form a luminaire with an up-light and down-light distribution pattern the depends on the rotated orientations of the planar light sources supported between the straight wall sections of said inner and outer support rings.

19. The luminaire of claim 18 wherein the top light emitting planar surface of each of said planar light sources produces a bat wing distribution pattern, and the bottom light emitting planar surface of each of said planar light sources produces a the substantially rotationally symmetric distribution pattern.

20. The luminaire of claim 19 wherein the bottom light emitting planar surface of each of said planar light sources produces a substantially cosine distribution pattern.
